(19) United States
(12) Patent Application Publication
(10) Pub. No.: US 2015/0339700 A1
(43) Pub. Date: Nov. 26, 2015

(54) METHOD, APPARATUS AND SYSTEM FOR PROCESSING PROMOTION INFORMATION

(71) Applicant: Alibaba Group Holding Limited, Grand Cayman (KY)

(72) Inventors: Chenfu Huo, Hangzhou (CN); Feng Lin, Hangzhou (CN); Bo Li, Hangzhou (CN)

(21) Appl. No.: 14/717,891

(22) Filed: May 20, 2015

(30) Foreign Application Priority Data
May 22, 2014 (CN) 201410218795.3

(51) Int. Cl. G06Q 30/02; G06F 17/30

(52) U.S. Cl. CPC G06Q 30/0243; G06F 17/3053; G06F 17/30542; G06Q 30/0277; G06Q 30/0247

(57) ABSTRACT

The present disclosure provides a method, an apparatus and a system for processing promotion information. In one aspect, embodiments of the present disclosure introduce a PS, which is used to characterize the quality of promotion information, into an eCTR as a new calculation factor, and therefore ensure the consistency between calculation logics of the PS and a RS, and can avoid the problem of inconsistency between the quality of the promotion information and the position of presenting the promotion information caused by the inconsistency between the calculation logics of the PS and the RS, thereby improving the effectiveness of pushing the promotion information.

### CROSS REFERENCE TO RELATED PATENT APPLICATION

This application claims foreign priority to Chinese Patent Application No. 201410218795.3 filed on May 22, 2014, entitled “Method, Apparatus and System for Processing Promotion Information”, which is hereby incorporated by reference in its entirety.

### TECHNICAL FIELD

The present disclosure relates to information pushing technologies, and in particular, to methods, apparatuses and systems for processing promotion information.

### BACKGROUND

In recent years, the development of Internet technologies has been accompanied by emerging promotion information pushing services, for example, advertisement pushing, game pushing, or application pushing. A Promotion Score (PS) of promotion information is a criterion of quality for the promotion information, i.e., relevance between the promotion information and a keyword, which can be obtained by a promoter when pushing the promotion information and is fed back only by a background operating platform. The promoter can select related keywords for the promotion information thereof according to the PS of the promotion information, and offers a price for each keyword, i.e., a bid price for the keyword, so that a search engine calculates a Rank Score (RS) of the promotion information under each query term based on the bid price offered by the promoter and an estimated Click Through Rate (eCTR) of the promotion information, to arrange a position of presenting the promotion information.

However, because computation logics of PS and RS are inconsistent, the quality of the promotion information may be inconsistent with the position of presenting the promotion information, for example, a situation where promotion information with a higher PS does not necessarily obtain a presentation position with a relatively high RS, which leads to a decrease in effectiveness of pushing the promotion information. Another problem is that the existing technologies fail to consider intervention from hidden terms and matching of category features. As such, the calculation of PS is not accurate enough.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to device(s), system(s), method(s) and/or computer-readable instructions as permitted by the context above and throughout the present disclosure.

Aspects of the present disclosure provide a method, an apparatus and a system for processing promotion information to improve the effectiveness of pushing the promotion information or improve the accuracy of a PS associated with the promotion information.

An aspect of the present disclosure provides a method for processing promotion information, which includes:

obtaining, based on a query term inputted by a user, promotion information matching the query term;

obtaining a content feature of the promotion information, a content feature of the query term, and a property of relevancy between the promotion information and the query term based on the promotion information and the query term;

obtaining an eCTR of the promotion information using an estimation model based on a PS of the promotion information, the content feature of the promotion information, the content feature of the query term, and the relative feature between the promotion information and the query term;

obtaining an RS of the promotion information based on the eCTR and a bid price for the query term; and

determining a position of presenting the promotion information based on the RS.

In an embodiment, prior to obtaining the eCTR of the promotion information using the estimation model based on the PS of the promotion information, the content feature of the promotion information, the content feature of the query term, and the relative feature between the promotion information and the query term, the method further includes:

obtaining, based on the promotion information and a keyword of the promotion information, a text match feature between the promotion information and the keyword and an intention match feature between the promotion information and the keyword; and

obtaining the PS of the promotion information using a rule model based on the text match feature between the promotion information and the keyword and the intention match feature between the promotion information and the keyword.

In an embodiment, obtaining the intention match feature between the promotion information and the keyword based on the promotion information and the keyword of the promotion information, includes:

obtaining an initial intention of the keyword based on the keyword;

obtaining an initial intention of the promotion information based on the promotion information; and

obtaining the intention match feature between the promotion information and the keyword based on the initial intention of the promotion information and the initial intention of the keyword.

In an embodiment, obtaining the initial intention of the keyword based on the keyword, includes:

obtaining a category match feature corresponding to the keyword based on a preset correspondence relationship between keywords and category match features; and

obtaining the initial intention of the keyword based on the keyword and the category match feature.

In an embodiment, obtaining the intention match feature between the promotion information and the keyword based on the initial intention of the promotion information and the initial intention of the keyword, includes:

revising at least one of the initial intention of the keyword and the initial intention of the promotion information using a hidden term intervene feature to obtain at least one of a revised intention of the keyword and a revised intention of the promotion information; and

obtaining the intention match feature between the promotion information and the keyword based on the initial intention of the promotion information and the revised intention of the keyword, the revised intention of the promotion information and the revised intention of the keyword, or the revised intention of the promotion information and the initial intention of the keyword.

In an embodiment, the relative feature between the promotion information and the query term includes a combined feature of the promotion information and the query term.

Another aspect of the present disclosure provides an apparatus for processing promotion information, which includes:

a matching unit to obtain, based on a query term inputted by a user, promotion information matching the query term;

a feature unit to obtain a content feature of the promotion information, a content feature of the query term, and a relative feature between the promotion information and the query term based on the promotion information and the query term;

an estimation unit to obtain an eCTR of the promotion information using an estimation model based on a PS of the promotion information, the content feature of the promotion information, the content feature of the query term, and the relative feature between the promotion information and the query term;

a scoring unit to obtain an RS of the promotion information based on the eCTR and a bid price for the query term; and

a determination unit to determine a position of presenting the promotion information based on the RS.

In an embodiment, the relative feature between the promotion information and the query term obtained by the feature unit includes a combined feature of the promotion information and the query term.

Another aspect of the present disclosure provides a system of processing promotion information, which includes a backend operating platform and the apparatus for processing of promotion information as provided in the foregoing aspects, where the backend operating platform is used for obtaining the PS of the promotion information.

In an embodiment, the backend operating platform is further used for:

obtaining, based on the promotion information and a keyword of the promotion information, a text match feature between the promotion information and the keyword and an intention match feature between the promotion information and the keyword; and

obtaining the PS of the promotion information using a rule model based on the text match feature between the promotion information and the keyword and the intention match feature between the promotion information and the keyword.

In an embodiment, the backend operating platform is further used for:

obtaining an initial intention of the keyword based on the keyword;

obtaining an initial intention of the promotion information based on the promotion information; and

obtaining the intention match feature between the promotion information and the keyword based on the initial intention of the promotion information and the initial intention of the keyword.

In an embodiment, the backend operating platform is further used for:

obtaining a category match feature corresponding to the keyword based on a preset correspondence relationship between keywords and category match features; and

obtaining the initial intention of the keyword based on the keyword and the category match feature.

In an embodiment, the backend operating platform is further used for:

revising at least one of the initial intention of the keyword and the initial intention of the promotion information using a hidden term intervene feature to obtain at least one of a revised intention of the keyword and a revised intention of the promotion information; and

obtaining the intention match feature between the promotion information and the keyword based on the initial intention of the promotion information and the revised intention of the keyword, the revised intention of the promotion information and the revised intention of the keyword, or the revised intention of the promotion information and the initial intention of the keyword.

Another aspect of the present disclosure provides another method for processing promotion information, which includes:

acquiring promotion information to be processed;

obtaining, based on the promotion information and a keyword of the promotion information, a text match feature between the promotion information and the keyword;

obtaining an intention match feature between the promotion information and the keyword based on the promotion information, the keyword of the promotion information, and a category match feature; and

obtaining a PS of the promotion information with respect to the keyword using a rule model and based on the text match feature between the promotion information and the keyword and the intention match feature between the promotion information and the keyword.

In an embodiment, obtaining the intention match feature between the promotion information and the keyword based on the promotion information, the keyword of the promotion information, and the category match feature includes:

obtaining the category match feature corresponding to the keyword based on a preset correspondence relationship between keywords and category match features; and

obtaining an initial intention of the keyword based on the keyword and the category match feature;

obtaining an initial intention of the promotion information based on the promotion information; and

obtaining the intention match feature between the promotion information and the keyword based on the initial intention of the promotion information and the initial intention of the keyword.

Another aspect of the present disclosure provides another method for processing promotion information, which includes:

acquiring promotion information to be processed;

obtaining, based on the promotion information and a keyword of the promotion information, a text match feature between the promotion information and the keyword;

obtaining an intention match feature between the promotion information and the keyword based on the promotion information, the keyword of the promotion information and a hidden term intervene feature; and

obtaining a PS of the promotion information with respect to the keyword using a rule model and based on the text match feature between the promotion information and the keyword and the intention match feature between the promotion information and the keyword.

In an embodiment, obtaining the intention match feature between the promotion information and the keyword based on the promotion information, the keyword of the promotion information and the hidden term intervene feature includes:

obtaining an initial intention of the keyword based on the keyword;

obtaining an initial intention of the promotion information based on the promotion information;

revising at least one of the initial intention of the keyword and the initial intention of the promotion information using the hidden term intervene feature, to obtain at least one of a revised intention of the keyword and a revised intention of the promotion information; and

obtaining the intention match feature between the promotion information and the keyword based on the initial intention of the promotion information and the revised intention of the keyword, the revised intention of the promotion information and the revised intention of the keyword, or the revised intention of the promotion information and the initial intention of the keyword.

Another aspect of the present disclosure provides another apparatus for processing promotion information, which includes:

an acquisition unit to acquire promotion information to be processed;

a text matching unit to obtain, based on the promotion information, a keyword of the promotion information, and a category match feature, a text match feature between the promotion information and the keyword;

an intention matching unit to obtain an intention match feature between the promotion information and the keyword based on the promotion information and the keyword of the promotion information; and

a scoring unit to obtain a PS of the promotion information with respect to the keyword using a rule model and based on the text match feature between the promotion information and the keyword and the intention match feature between the promotion information and the keyword.

In an embodiment, the intention matching unit is further used for:

obtaining a category match feature corresponding to the keyword according to a preset correspondence relationship between keywords and category match features;

obtaining an initial intention of the keyword based on the keyword and the category match feature;

obtaining an initial intention of the promotion information based on the promotion information; and

obtaining the intention match feature between the promotion information and the keyword based on the initial intention of the promotion information and the initial intention of the keyword.

Another aspect of the present disclosure provides another apparatus for processing promotion information, which includes:

an acquisition unit to acquire promotion information to be processed;

a text matching unit to obtain, based on the promotion information and a keyword of the promotion information, a text match feature between the promotion information and the keyword;

an intention matching unit to obtain an intention match feature between the promotion information and the keyword based on the promotion information, the keyword of the promotion information, and a hidden term intervene feature; and

a scoring unit to obtain a PS of the promotion information with respect to the keyword using a rule model and based on the text match feature between the promotion information and the keyword and the intention match feature between the promotion information and the keyword.

In an embodiment, the intention matching unit is further used for:

obtaining an initial intention of the keyword based on the keyword;

obtaining an initial intention of the promotion information based on the promotion information;

revising at least one of the initial intention of the keyword and the initial intention of the promotion information using the hidden term intervene feature, to obtain at least one of a revised intention of the keyword and a revised intention of the promotion information; and

obtaining the intention match feature between the promotion information and the keyword based on the initial intention of the promotion information and the revised intention of the keyword, the revised intention of the promotion information and the revised intention of the keyword, or the revised intention of the promotion information and the initial intention of the keyword.

As can be understood from the foregoing technical solutions, in one aspect, embodiments of the present disclosure obtain, based on a query term inputted by a user and promotion information that matches the query term, a content feature of the promotion information, a content feature of the query term, and a relative feature between the promotion information and the query term, and thereby, further obtain an eCTR of the promotion information using an estimation model based on a PS of the promotion information, the content feature of the promotion information, the content feature of the query term, and the relative feature between the promotion information and the query term. As such, an RS of the promotion information can be obtained based on the eCTR and a bid price of the query term, so that a presentation position of the promotion information can be determined according to the RS. Because the PS that is used for representing the quality of the promotion information is introduced into the eCTR as a new factor of computation, the consistency between calculation logics of the PS and RS is ensured, thus avoiding the problem of inconsistency between the quality of the promotion information and the presentation position of the promotion information caused by the inconsistency between the calculation logics of the PS and RS, and thereby improving the effectiveness of pushing the promotion information.

In addition, by employing the technical solutions provided by the present disclosure, a position of presenting promotion information can be improved by optimizing the quality of the promotion information because the PS representing the quality of the promotion information is introduced as a new factor into a calculation of the eCTR, thus satisfying the revenue demand of a promoter in a better manner.

In addition, by using the technical solutions provided by the present disclosure, since a text match feature between the query term and the promotion information and an intention match feature between the query term and the promotion information are calculation factors of the PS of the promotion information among relative features between the promotion information and the query term, the PS of the promotion information may be introduced as a new calculation factor for the eCTR in place of the text match feature between the query term and the promotion information and the intention match feature between the query term and the promotion information among the relative features between the promotion information and the query term. Therefore, the text match feature between the query term and the promotion information and the intention match feature between the query term and the promotion information do not need to participate in a calculation for the eCTR, thus effectively reducing the complexity of eCTR estimation, and thereby improving the query efficiency.

In addition, by using the technical solutions provided by the present disclosure, a calculation logic of the PS of the promotion information is not changed. Therefore, in a situation where content of the promotion information does not change, the PS of the promotion information only needs to be calculated once before being stored into a database, and does not need to be updated, thus effectively avoiding a waste of computing resources and not affecting computing performance.

As can be seen from the foregoing technical solutions, in another aspect, the embodiments of the present disclosure obtain a category match feature corresponding to a keyword according to a preset correspondence relationship between keywords and category match features, and further obtain an initial intention of the keyword based on the keyword and the category match feature. Therefore, the reliability of acquiring an intention matching property between the promotion information and the keyword can be effectively improved, thereby improving the accuracy of the PS calculation.

As can be seen from the foregoing technical solutions, in another aspect, the embodiments of the present disclosure revise at least one of the initial intention of the keyword and the initial intention of the promotion information using a hidden term intervene feature, to obtain at least one of a revised intention of the keyword and a revised intention of the promotion information, and further obtain the intention match feature between the promotion information and the keyword based on the initial intention of the promotion information of the revised intention of the keyword, the revised intention of the promotion information and the revised intention of the keyword, or the revised intention of the promotion information and the initial intention of the keyword. Therefore, the reliability of acquiring the intention match feature between the promotion information and the keyword can be effectively improved, thereby improving the accuracy of the PS calculation.

### BRIEF DESCRIPTION OF THE DRAWINGS

In order to describe the technical solutions in the embodiments of the present disclosure more clearly, accompanying drawings needed for describing the embodiments or the existing technologies are briefly described herein. Apparently, the drawings in the following description represent some embodiments of the present disclosure. One of ordinary skill in the art can further derive other drawings based on these accompanying drawings without making any creative efforts.

FIG. 1 is a schematic flowchart of a method for processing promotion information according to an embodiment of the present disclosure.

FIG. 2 is a schematic structural diagram of an apparatus for processing promotion information according to another embodiment of the present disclosure.

FIG. 3 is a schematic structural diagram of a system of processing promotion information according to another embodiment of the present disclosure.

FIG. 4 is a schematic flowchart of another method for processing promotion information according to another embodiment of the present disclosure.

FIG. 5 is a schematic flowchart of another method for processing promotion information according to another embodiment of the present disclosure.

FIG. 6 is a schematic structural diagram of another apparatus for processing promotion information according to another embodiment of the present disclosure.

FIG. 7 is a schematic structural diagram of another apparatus for processing promotion information according to another embodiment of the present disclosure.

FIG. 8 is a schematic structural diagram illustrating the example apparatus as shown in FIGS. 2, 6 and 7 in more detail.

### DETAILED DESCRIPTION

In order to make objectives, technical solutions and advantages of the embodiments of the present disclosure in a clearer manner, the technical solutions of the embodiments of the present disclosure are described clearly and completely with reference to the accompanying drawings in the embodiments of the present disclosure. Apparently, the embodiments described represent some and not all of embodiments of the present disclosure. Based on the embodiments of the present disclosure, all other embodiments obtained by one of ordinary skill in the art without making any creative effort shall fall in the protection scope of the present disclosure.

It should be noted that a terminal involved in the embodiments of the present disclosure may include, but is not limited to, a mobile phone, a Personal Digital Assistant (PDA), a wireless handheld device, a wireless netbook, a personal computer, a portable computer, a tablet computer, an MP3 player, an MP4 player, a wearable device (such as smart glasses, a smart watch, and a smart band), and the like.

In addition, the term “and/or” herein merely is an association relationship describing associated objects, and represents existences of three types of relationships. For example, A and/or B may represent: an existence of A only, an existence of both A and B, and an existence of B only. In addition, the symbol “/” generally represents herein an “or” relationship between associated objects that are in front of and behind the symbol.

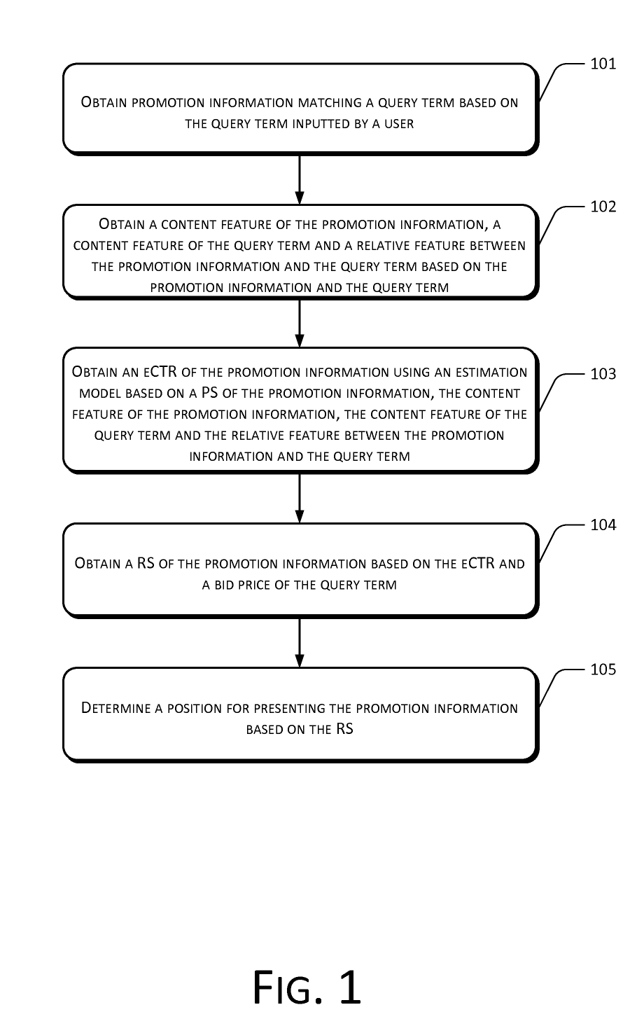

FIG. 1 is a schematic flowchart of a method for processing promotion information according to an embodiment of the present disclosure. As shown in FIG. 1, this processing method includes five execution modules 101-105.

It should be noted that an entity performing 101-105 may be a search engine, and may be located in a local application or in a server on a network side, which this embodiment does not impose any specific limitation thereon.

It can be understood that the application may be an application program (nativeApp) installed in a terminal, or may be a web page (webApp) of a browser in the terminal, and may exist in any objective form as long as being capable of implementing a search based on a query term to provide promotion information matching the query term. This embodiment does not impose any limitation thereon.

At 101: Based on a query term entered by a user, promotion information matching the query term is obtained.

Optionally, in an implementation, at 101, a search engine may use an exact matching method to match exactly a keyword that is selected by a promoter for promotion information and corresponds to the query term inputted by the user, or the search engine may use a fuzzy matching method to match approximately a keyword that is selected by the promoter for the promotion information and corresponds to the query term inputted by the user, and then obtains the promotion information tied to the keyword based on the matched keyword. The present embodiment does not have any limitation on the matching method used for the query term.

Specifically, a promoter may select one or more related keywords for promotion information based on the promotion information. For example, if the promotion information is an advertisement of a flower shop, a keyword of “flower” may be selected for the promotion information, or multiple keywords, for example, “flower”, “flower delivery”, and “flower booking” may be selected.

Detailed description of the exact matching method and fuzzy matching method used by the search engine may be referenced to related content in the existing technologies, which are not described in detail herein.

It can be understood that the promotion information obtained by the search engine at 101 may include multiple pieces of promotion information, and any piece of promotion information tied to the keyword that is able to match the query term may be used as an execution result of 101.

At 102: A content feature of the promotion information, a content feature of the query term, and a relative feature between the promotion information and the query term are obtained based on the promotion information and the query term.

Optionally, in an implementation, at 102, the search engine may obtain the content feature of the promotion information based on the promotion information. Examples include a key term of the title of the promotion information, a high-frequency term in the title of the promotion information, identification information (ID) of the promotion information, a category identifier of the promotion information, and a historical average click through rate of the promotion information, etc.

Optionally, in an implementation, at 102, the search engine may obtain the content feature of the query term based on the query term. Examples include identification information (ID) of the query term, a name in the query term, the query term per se, an adjective in the query term, a model in the query term, and a historical average click through rate of the query term, etc.

Optionally, in an implementation, at 102, the search engine may obtain a relative feature between the promotion information and the query term based on the promotion information and the query term.

Specifically, the relative feature between the promotion information and the query term may include a combined feature of the text match feature and an intention match feature. An example includes a combined feature of the key term of the title of the promotion information and the query term. Another example includes a combined feature of the ID of the promotion information and the ID of the query term, etc.

At 103: An eCTR of the promotion information is obtained using an estimation model based on a PS of the promotion information, the content feature of the promotion information, the content feature of the query term, and the relative feature between the promotion information and the query term.

Since the text match feature between the query term and the promotion information and the intention match feature between the query term and the promotion information are factors for calculating PS of the promotion information from among the relative features between the promotion information and the query term, the PS of the promotion information may be introduced as a new factor in a calculation of an eCTR in place of the text match feature between the query term and the promotion information and the intention match feature between the query term and the promotion information among the relative features between the promotion information and the query term. Therefore, the text match feature between the query term and the promotion information and the intention match feature between the query term and the promotion information do not need to be involved in the calculation of the eCTR, thus effectively reducing the complexity of eCTR estimation and thereby improving the query efficiency.

Optionally, in an implementation, at 103, the search engine may obtain the PS of the promotion information corresponding to the promotion information based on the promotion information using a correspondence relationship between pieces of promotion information and respective PSs of the pieces of promotion information, which is obtained in advance.

It can be understood that the promotion information may generally have more than one keyword. Therefore, the promotion information may correspondingly have more than one PSs. Specifically, a determination of which PS is selected by the search engine further needs to be performed based on the query term entered by the user.

For example, the search engine may select a PS of the promotion information with respect to a keyword that is most similar to the query term entered by the user. A specific matching method may be referenced to related content of any text matching method in the existing technologies, which is not described in detail herein.

Specifically, prior to 103, a correspondence relationship between pieces of promotion information and respective PSs of the pieces of promotion information may further be set up. Specifically, a backend operating platform may obtain the text match feature between the promotion information and the keyword and the intention match feature between the promotion information and the keyword based on the promotion information and the keyword of the promotion information. Thereafter, the backend operating platform may obtain a PS of the promotion information using a rule model based on the text match feature between the promotion information and the keyword and the intention match feature between the promotion information and the keyword to set up a correspondence relationship between the promotion information and the PS of the promotion information.

Specifically, the rule model may be obtained by training a Gradient Boosting Decision Tree (GBDT) model using data associated with user clicking activities. Features of the rule model may include, but are not limited to, the text match feature between the promotion information and the keyword, and the intention match feature between the promotion information and the keyword.

Specifically, the backend operating platform may obtain a text of the keyword based on the keyword, obtain a text of the promotion information based on the promotion information, and therefore may obtain the text match feature between the promotion information and the keyword based on the text of the promotion information and the text of the keyword.

For example, the text match feature between the promotion information and the keyword, which is abbreviated as the text match feature hereinafter, may be a matching rate between a term in the keyword and a term in the title of the promotion information. For example, assuming that the keyword is “mp3 player” and the title of the promotion information is “2014 best-selling red mp3”, a term of the keyword that matches the title is mp3, and a matching rate with respect to a length of the keyword is ½ and a matching rate with respect to a length of the title is ⅕. Generally speaking, the larger the value of the text match feature is, the higher the relevance between the promotion information and the keyword is. In other words, the quality of the promotion information is higher, and the PS of the promotion information is greater.

Specifically, the backend operating platform may obtain an initial intention of the keyword according to the keyword, and obtain an initial intention of the promotion information according to the promotion information, and further obtain the intention match feature between the promotion information and the keyword according to the initial intention of the promotion information and the initial intention of the keyword.

For example, the intention match feature between the promotion information and the keyword, which is abbreviated as the intention match feature hereinafter, may be a parameter indicating whether a key term of the keyword and a key term of the title of the promotion information are the same. For example, the keyword is assumed to be “battery of Nokia phone”, the title of promotion information A is assumed to be “2014 best-selling battery for Nokia phone, the lowest price”, and the title of promotion information B is assumed to be “2014 best-selling Nokia phone, with the best performance battery”. In terms of the text match feature, a matching rate between a term in the keyword and a term in the title of promotion information A and a matching rate between a term in the keyword and a term in the title of promotion information B are both 3/10, that is, respective text match features are the same. However, the key term of the keyword is battery (i.e., the user desires a search result to be battery), the key term of the title of promotion information A is battery (i.e., battery for Nokia phone), and the key term of the title of promotion information B is Nokia phone; the relevance between the keyword and promotion information A is measured to be higher than the relevance between the keyword and promotion information B using the intention match feature, that is, the quality of promotion information A is better than the quality of promotion information B.

The meaning of some keywords covers a wide range, and thus an initial intention of a keyword may not be accurately determined based on the keyword. Optionally, the backend operating platform may obtain a category match feature corresponding to the keyword according to a preset correspondence relationship between keywords and category match features, and thereby obtain an initial intention of the keyword based on the keyword and the category match feature. Specifically, the backend operating platform may obtain the correspondence relationship between the keywords and the category match features based on data associated with user clicking behavior. In this way, the reliability of acquiring the intention match feature between the promotion information and the keyword can be effectively improved, thereby improving the accuracy of the PS calculation.

For example, if no auxiliary information exists, the backend operating platform may hardly obtain a real intention of a user with regard to a keyword of “2014 women”, resulting in a difficulty of the backend operating platform to provide promotion information expected by the user. If data about user clicking behavior in a specified time range, for example, in the last month, shows that 60% of the users click products belonging to a category of female clothes and 40% of the users click products belonging to a category of female shoes after users input the query term “2014 women”, the backend operating platform may predict that the category match feature of the keyword “2014 women” corresponds to female clothes and female shoes based on the data about the user clicking behavior. With this prediction result for the category match feature of “2014 women”, a PS of promotion information is determined as “excellent” when a promoter uses the backend operating platform to push the promotion information belonging to categories of female clothes and female shoes and if “2014 women” is selected as a keyword to which the promotion information is bound.

Therefore, in an implementation, a formula that the backend operating platform uses for calculating a PS of promotion information may be expressed as follows:

PS=f1(fea_{—}tm,fea_{—}im,fea_{—}cm),

where fea_tm may represent the text match feature between the promotion information and the keyword; fea_im may represent the intention match feature between the promotion information and the keyword; fea_cm may represent the category match feature; and the function f1 may represent the rule model obtained by training the GBDT model. For detailed description, reference may be made to related content of the GBDT model training method in the existing technologies, which is not described in detail herein.

Key terms of titles of some promotion information or key terms of some keywords may be identified incorrectly, and in this case, an initial intention of promotion information cannot be accurately determined based on a key term recognized. Optionally, the backend operating platform may use a hidden term intervene feature to revise at least one of an initial intention of the keyword and an initial intention of the promotion information to obtain at least one of a revised intention of the keyword and a revised intention of the promotion information, and further obtain the intention match feature between the promotion information and the keyword based on the initial intention of the promotion information and the revised intention of the keyword, the revised keyword of the promotion information and the revised intention of the keyword, or the revised intention of the promotion information and the initial intention of the keyword. In this way, the reliability of acquiring the intention match feature between the promotion information and the keyword can be effectively improved, thus improving the accuracy of the PS calculation.

For example, the keyword is assumed to be “iPhone” and the title of the promotion information is assumed to be “2014 best-selling iPhone case”. If “iPhone” is recognized as the key term of the title, the backend operating platform will determine the promotion information matches an intention of the keyword. However, content of the promotion information is actually an iPhone case, wherein “case” is a hidden term. In other words, the promotion information does not match the intention of the keyword. In order to avoid the situation described above, the backend operating platform may use a stored hidden term intervene feature. If the title of the promotion information includes “case”, the backend operating platform will revise the key term “iPhone” of the title as “iPhone case” to ensure that the real intention of the promotion information can be recognized correctly and is not misunderstood.

Therefore, in another implementation, a formula that the backend operating platform uses for calculating the PS of the promotion information may be expressed in a form as follows:

PS=f1(fea_{—}tm,fea_{—}im,fea_{—}it),

where fea_tm may represent the text match feature between the promotion information and the keyword; fea_im may represent the intention match feature between the promotion information and the keyword; fea_it may represent the hidden term intervene feature; and the function f1 may represent the rule model obtained by training the GBDT model. For detailed description, reference may be made to related content of the GBDT model training method in the existing technologies, which will not be described in detail herein.

With reference to the content provided by the two implementations described above, in another implementation, a formula that the background operating platform uses for calculating the PS of the promotion information may be expressed in a form as follows:

PS=f1(fea_{—}tm,fea_{—}im,fea_{—}it,fea_{—}cm),

where fea_tm may represent the text match feature between the promotion information and the keyword; fea_im may represent the intention match feature between the promotion information and the keyword; fea_it may represent the hidden term intervene feature; fea_cm may represent the category match feature; and the function f1 may represent the rule model obtained by training the GBDT model. For detailed description, reference may be made to related content of the GBDT model training method in the existing technologies, which will not be described in detail herein.

Specifically, the rule model may be obtained by training a Logistic Regression (LR) model by using data about user clicking behavior. Features of the estimation model may include, but are not limited to, the PS of the promotion information, the content feature of the promotion information, the content feature of the query term, and the relative feature between the promotion information and the query term.

Specifically, a content format of the data about user clicking behavior may be represented in Table 1, which may include, but is not limited to, fields such as a query term (Query), identification information of promotion information (Product_ID), a title of the promotion information (Title), a presentation position of the promotion information (Rank), and whether the promotion information is clicked (Is_Click), etc.

TABLE 1
Data about user clicking behavior

| Number | Name | Description |
|---|---|---|
| 1 | Query | Query term |
| 2 | Product_ID | Identification information of promotion information |
| 3 | Title | Title of promotion information |
| 4 | Rank | Presentation position of promotion information |
| 5 | Is_Click | Whether promotion information is clicked |
| . . . | . . . | . . . |

Optionally, before training the model using the data about user clicking behavior, the backend operating platform may further perform preprocessing, such as anti-fraud and anti-crawler data filtering, false exposure data filtering, etc., on the data about user clicking behavior.

For example, according to a length of time during which a user stays on each web page, a determination is made as to whether the promotion information is actually exposed (browsed by the user) to filter out false exposure having a too short stay time, thus effectively improving the quality of data about user clicking behavior obtained after preprocessing.

Specifically, a preprocessing model represented by the following formula may be used to preprocess the data about user clicking behavior:

$$P ( {E}_{i} = 1 \vert {t}_{i} ) = \{ \begin{matrix}1 , {t}_{i} \geq T \\ 0 , {t}_{i} < T\end{matrix} ,$$

wherein t represents a stay time, and T is a threshold obtained based on statistics of a large quantity of data. When t≧T, this indicates that the user has stayed on the page long enough, and really browses the promotion information presented on the page, or otherwise, the promotion information presented on the page is not really exposed. For example, when the user quickly drags a scroll bar of a search result page from the top to the bottom, the promotion information presented in the middle is not browsed by the user, and is not counted as a real exposure. Such data may be excluded when selecting sample data to improve the credibility of the sample data for the estimation model.

Based on the above description, a formula that the search engine uses for calculating the eCTR may be expressed in a form as follows:

eCTR=f2(fea_{—}p,fea_{—}q,fea_{—}r,fea_{—}ps),

fea_p may represent the content feature of the promotion information (product); fea_q may represent the content feature of the query term (query); fea_r may represent the relative feature between the promotion information and the query term; fea_ps may represent the PS feature of the promotion information; and the function f2 may represent the estimation model obtained by training the LR model. For detailed description, reference may be made to related content of the LR model training method in the existing technologies, which is not described in detail herein.

At 104: An RS of the promotion information is obtained based on the eCTR and a bid price of the query term.

Optionally, in an implementation, at 104, the search engine may obtain the RS of the promotion information based on the eCTR and the bid price of the query term. For example, the RS may be calculated using a formula of RS=eCTR*BidPrice.

At 105: A position for presenting the promotion information is determined based on the RS.

Optionally, in an implementation, at 105, the search engine may determine the position for presenting the promotion information based on an inverted order of respective RSs of each piece of promotion information.

In this embodiment, based on a query term entered by a user and promotion information matching the query term, a content feature of the promotion information, a content feature of the query term, and a relative feature between the promotion information and the query term are obtained. Accordingly, an eCTR of the promotion information is obtained using an estimation model based on a PS of the promotion information, the content feature of the promotion information, the content feature of the query term, and the relative feature between the promotion information and the query term. As such, an RS of the promotion information may be obtained based on the eCTR and a bid price of the query term. A presentation position of the promotion information may accordingly be determined based on the RS. Because the PS that is used for representing the quality of the promotion information is introduced as a new factor into the calculation of the eCTR, the consistency between calculation logics of the PS and the RS is ensured. Thus, the problem of inconsistency between the quality of the promotion information and the presentation position of the promotion information caused by the inconsistency between the calculation logics of the PS and the RS can be avoided, thereby improving the effectiveness of pushing the promotion information.

In addition, by employing the technical solutions provided by the present disclosure, a position of presenting promotion information can be improved by optimizing the quality of the promotion information because the PS representing the quality of the promotion information is introduced as a new factor into a calculation of the eCTR, thus satisfying the revenue demand of a promoter in a better manner.

In addition, by using the technical solutions provided by the present disclosure, since a text match feature between the query term and the promotion information and an intention match feature between the query term and the promotion information are calculation factors of the PS of the promotion information among relative features between the promotion information and the query term, the PS of the promotion information may be introduced as a new calculation factor for the eCTR in place of the text match feature between the query term and the promotion information and the intention match feature between the query term and the promotion information among the relative features between the promotion information and the query term. Therefore, the text match feature between the query term and the promotion information and the intention match feature between the query term and the promotion information do not need to participate in a calculation for the eCTR, thus effectively reducing the complexity of eCTR estimation, and thereby improving the query efficiency.

In addition, by using the technical solutions provided by the present disclosure, a calculation logic of the PS of the promotion information is not changed. Therefore, in a situation where content of the promotion information does not change, the PS of the promotion information only needs to be calculated once before being stored into a database, and does not need to be updated, thus effectively avoiding a waste of computing resources and not affecting computing performance.

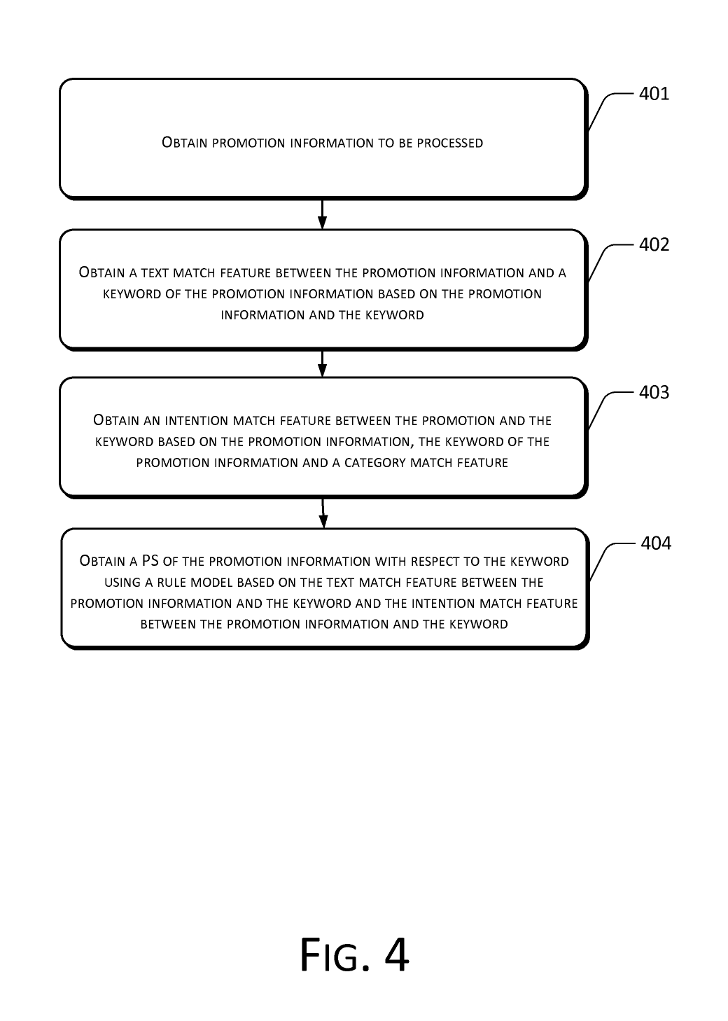

FIG. 4 is a schematic flowchart of another method for processing promotion information according to another embodiment of the present disclosure. As shown in FIG. 4, the processing method includes four execution modules 401-404.

It should be noted that an entity executing 401-404 may be a processing apparatus, and may be located in a backend operating platform on a network side, which this embodiment does not impose any limitation thereon.

At 401: Promotion information to be processed is obtained.

At 402: Based on the promotion information and a keyword of the promotion information, a text match feature between the promotion information and the keyword is obtained.

At 403: An intention match feature between the promotion information and the keyword is obtained based on the promotion information, the keyword of the promotion information and a category match feature.

At 404: A PS of the promotion information with respect to the keyword is obtained using a rule model based on the text match feature between the promotion information and the keyword, and the intention match feature between the promotion information and the keyword.

Specifically, the rule model may be obtained by training a Gradient Boosting Decision Tree (GBDT) model using data associated with user clicking activities. Features of the rule model may include, but are not limited to, the text match feature between the promotion information and the keyword, and the intention match feature between the promotion information and the keyword, etc.

Optionally, in an implementation, at 402, the processing apparatus may obtain a text of the keyword according to the keyword, obtain a text of the promotion information according to the promotion information, and further obtain the text match feature between the promotion information and the keyword based on the text of the promotion information and the text of the keyword.

For example, the text match feature between the promotion information and the keyword, which is abbreviated as the text match feature hereinafter, may be a matching rate between a term in the keyword and a term in the title of the promotion information. For example, if the keyword is “mp3 player” and the title of the promotion information is “2014 best-selling red mp3”, a matching word between the keyword and the title is mp3, a matching rate with respect to a length of the keyword is ½, and a matching rate with respect to a length of the title is ⅕. Generally speaking, a larger value of the text match feature indicates a higher relevance between the promotion information and the keyword, i.e., a higher quality of the promotion information. Thus, the PS of the promotion information is higher.

Optionally, in an implementation, at 403, the processing apparatus may obtain an initial intention of the keyword according to the keyword, obtain an initial intention of the promotion information according to the promotion information, and further obtain the intention match feature between the promotion information and the keyword based on the initial intention of the promotion information and the initial intention of the keyword.

For example, the intention match feature between the promotion information and the keyword, which is abbreviated as the intention match feature hereinafter, may be a parameter indicating whether a key term of the keyword and a key term of the title of the promotion information are the same. For example, the keyword is assumed to “battery of Nokia phone”, the title of promotion information A is assumed to “2014 best-selling battery for Nokia phone, the lowest price”, and the title of promotion information B is assumed to “2014 best-selling Nokia phone, with battery the best performance”. In terms of the text match feature, a matching rate between a term in the keyword and a term in the title of promotion information A and a matching rate between a term in the keyword and a term in the title of promotion information B are both 3/10, that is, respective text match features are the same. However, a key term of the keyword is battery (the user desire a search result as battery), a key term of the title of promotion information A is battery (battery for Nokia phone), and a key term of the title of promotion information B is Nokia phone. Using the intention match feature, the relevance between the keyword and promotion information A is measured to be higher than the relevance between the keyword and promotion information B, that is, the quality of promotion information A is better than the quality of promotion information B.

The meaning of some keywords covers a wide range, and thus an initial intention of the keyword may not be accurately determined based on the keyword. Specifically, at 403, the processing apparatus may obtain a category match feature corresponding to the keyword according to a preset correspondence relationship between keywords and category match features, and thereby obtain an initial intention of the keyword based on the keyword and the category match feature. Specifically, the processing apparatus may obtain a correspondence relationship between keywords and category match features based on data associated with user clicking activities. In this way, the reliability of acquiring the intention match feature between the promotion information and the keyword can be effectively improved, thereby improving the accuracy of the PS calculation.

For example, if no auxiliary information exists, the processing apparatus may hardly obtain a real intention of a user with regard to a keyword of “2014 women”, resulting in a difficulty of the processing apparatus to provide promotion information expected by the user. If data about user clicking behavior in a specified time range, for example, in the last month, shows that 60% of the users click products belonging to a category of female clothes and 40% of the users click products belonging to a category of female shoes after users input the query term “2014 women”, the processing apparatus may predict that the category match feature of the keyword “2014 women” corresponds to female clothes and female shoes based on the data about the user clicking behavior. With this prediction result for the category match feature of “2014 women”, a PS of promotion information is determined as “excellent” when a promoter uses the processing apparatus to push the promotion information belonging to categories of female clothes and female shoes and if “2014 women” is selected as a keyword to which the promotion information is bound.

Therefore, in an implementation, a formula that the processing apparatus uses for calculating a PS of promotion information may be expressed as follows:

PS=f1(fea_{—}tm,fea_{—}im,fea_{—}cm),

where fea_tm may represent the text match feature between the promotion information and the keyword; fea_im may represent the intention match feature between the promotion information and the keyword; fea_cm may represent the category match feature; and the function f1 may represent the rule model obtained by training the GBDT model. For detailed description, reference may be made to related content of the GBDT model training method in the existing technologies, which is not redundantly described in detail herein.

In this embodiment, a category match feature corresponding to a keyword is obtained based on a preset correspondence relationship between keywords and category match features. As such, an initial intention of the keyword is obtained based on the keyword and the category match feature, so that the reliability of acquiring the intention match feature between the promotion information and the keyword can be effectively improved, thereby improving the accuracy of the PS calculation.

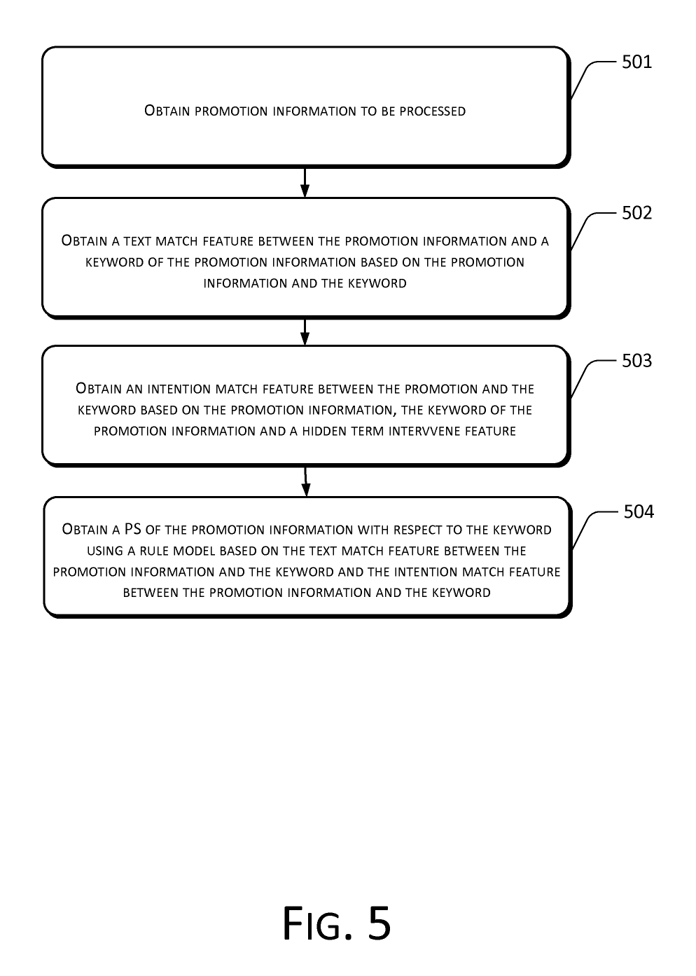

FIG. 5 is a schematic flowchart of another method for processing promotion information according to another embodiment of the present disclosure. As shown in FIG. 5, the processing method includes four execution modules 501-504.

It should be noted that an entity executing 501-504 may be a processing apparatus, and may be located in a backend operating platform on a network side, which this embodiment does not impose any limitation thereon.

At 501: Promotion information to be processed is obtained.

At 502: Based on the promotion information and a keyword of the promotion information, a text match feature between the promotion information and the keyword is obtained.

At 503: An intention match feature between the promotion information and the keyword is obtained based on the promotion information, the keyword of the promotion information, and a hidden term intervene feature.

At 504: A PS of the promotion information with respect to the keyword is obtained using a rule model based on the text match feature between the promotion information and the keyword, and the intention match feature between the promotion information and the keyword.

Specifically, the rule model may be obtained by training a Gradient Boosting Decision Tree (GBDT) model using data about user clicking behavior. Features of the rule model may include, but are not limited to, the text match feature between the promotion information and the keyword, and the intention match feature between the promotion information and the keyword, etc.

Optionally, in an implementation, at 502, the processing apparatus may obtain a text of the keyword according to the keyword, and obtain a text of the promotion information according to the promotion information, and further obtain the text match feature between the promotion information and the keyword based on the text of the promotion information and the text of the keyword.

For example, the text match feature between the promotion information and the keyword, which is abbreviated as the text match feature hereinafter, may be a matching rate between a term in the keyword and a term in the title of the promotion information. For example, if the keyword is “mp3 player” and the title of the promotion information is “2014 best-selling red mp3”, a matching word between the keyword and the title is mp3, a matching rate with respect to a length of the keyword is ½, and a matching rate with respect to a length of the title is ⅕. Generally speaking, a larger value of the text match feature indicates a higher relevance between the promotion information and the keyword, i.e., a higher quality of the promotion information. Thus, the PS of the promotion information is higher.

Optionally, in an implementation, at 503, the processing apparatus may obtain an initial intention of the keyword according to the keyword, obtain an initial intention of the promotion information according to the promotion information, and further obtain the intention match feature between the promotion information and the keyword based on the initial intention of the promotion information and the initial intention of the keyword.

For example, the intention match feature between the promotion information and the keyword, which is abbreviated as the intention match feature hereinafter, may be a parameter indicating whether a key term of the keyword and a key term of the title of the promotion information are the same. For example, the keyword is assumed to “battery of Nokia phone”, the title of promotion information A is assumed to “2014 best-selling battery for Nokia phone, the lowest price”, and the title of promotion information B is assumed to “2014 best-selling Nokia phone, with battery the best performance”. In terms of the text match feature, a matching rate between a term in the keyword and a term in the title of promotion information A and a matching rate between a term in the keyword and a term in the title of promotion information B are both 3/10, that is, respective text match features are the same. However, a key term of the keyword is battery (the user desire a search result as battery), a key term of the title of promotion information A is battery (battery for Nokia phone), and a key term of the title of promotion information B is Nokia phone. Using the intention match feature, the relevance between the keyword and promotion information A is measured to be higher than the relevance between the keyword and promotion information B, that is, the quality of promotion information A is better than the quality of promotion information B.

Key terms of titles of some promotion information or key terms of some keywords may be identified incorrectly, and in this case, an initial intention of promotion information cannot be accurately determined based on a key term recognized. Specifically, at 503, the processing apparatus may use a hidden term intervene feature to revise at least one of an initial intention of the keyword and an initial intention of the promotion information to obtain at least one of a revised intention of the keyword and a revised intention of the promotion information, and further obtain the intention match feature between the promotion information and the keyword based on the initial intention of the promotion information and the revised intention of the keyword, the revised keyword of the promotion information and the revised intention of the keyword, or the revised intention of the promotion information and the initial intention of the keyword. In this way, the reliability of acquiring the intention match feature between the promotion information and the keyword can be effectively improved, thus improving the accuracy of the PS calculation.

For example, the keyword is assumed to be “iPhone” and the title of the promotion information is assumed to be “2014 best-selling iPhone case”. If “iPhone” is recognized as the key term of the title, the backend operating platform will determine the promotion information matches an intention of the keyword. However, content of the promotion information is actually an iPhone case, wherein “case” is a hidden term. In other words, the promotion information does not match the intention of the keyword. In order to avoid the situation described above, the backend operating platform may use a stored hidden term intervene feature. If the title of the promotion information includes “case”, the backend operating platform will revise the key term “iPhone” of the title as “iPhone case” to ensure that the real intention of the promotion information can be recognized correctly and is not misunderstood.

Therefore, in another implementation, a formula that the processing apparatus uses for calculating the PS of the promotion information may be expressed in a form as follows:

PS=f1(fea_{—}tm,fea_{—}im,fea_{—}it),

where fea_tm may represent the text match feature between the promotion information and the keyword; fea_im may represent the intention match feature between the promotion information and the keyword; fea_it may represent the hidden term intervene feature; and the function f1 may represent the rule model obtained by training the GBDT model. For detailed description, reference may be made to related content of the GBDT model training method in the existing technologies, which is not redundantly described in detail herein.

In this embodiment, at least one of an initial intention of a keyword and an initial intention of promotion information is revised using a hidden term intervene feature to obtain at least one of a revised intention of the keyword and a revised intention of the promotion information. As such, an intention match feature between the promotion information and the keyword is obtained based on the initial intention of the promotion information of the revised intention of the keyword, the revised intention of the promotion information and the revised intention of the keyword, or the revised intention of the promotion information and the initial intention of the keyword. Therefore, the reliability of acquiring the intention match feature between the promotion information and the keyword can be effectively improved, thereby improving the accuracy of the PS calculation.

It should be noted that the foregoing method embodiments are expressed as a series of action combinations for the sake of description. One skilled in the art should understand that the present disclosure is not limited to the described order of actions, because some method blocks may be performed in a different order or in parallel according to the present disclosure. Furthermore, one skilled in the art should also understand that the embodiments described in the specification are all exemplary embodiments, and the actions and modules involved are not mandatory to the present disclosure.

In the foregoing embodiments, the description of each of the embodiments focuses on a different part, and for the part that is not described in detail in a certain embodiment, reference may be made to related descriptions in other embodiments.

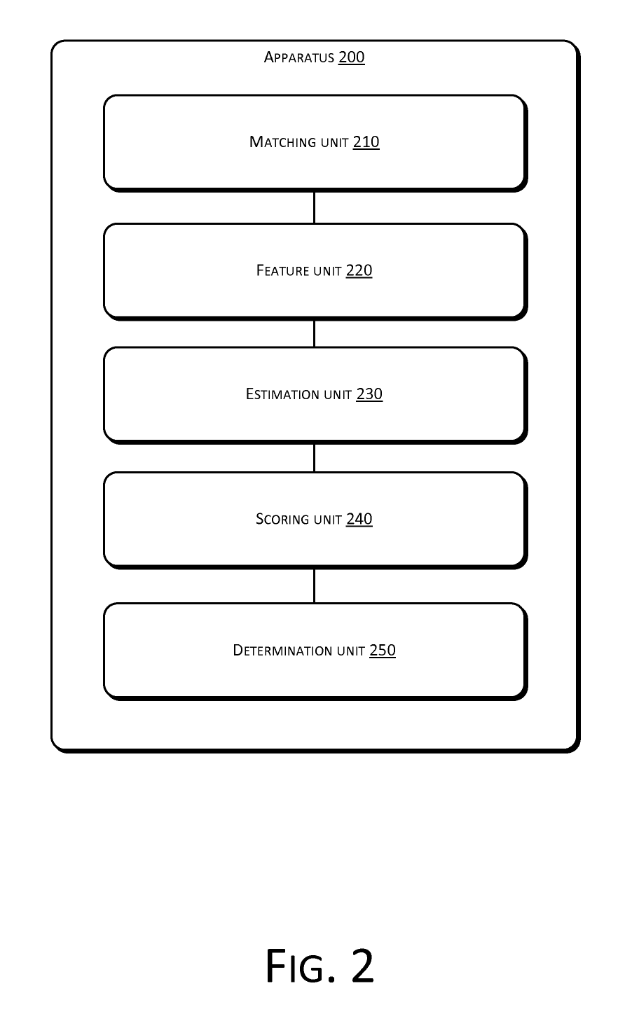

FIG. 2 is a schematic structural diagram of an apparatus 200 for processing promotion information according to another embodiment of the present disclosure. As shown in FIG. 2, the example apparatus 200 for processing promotion information may include a matching unit 210, a feature unit 220, an estimation unit 230, a scoring unit 240, and a determination unit 250. The matching unit 210 is used to obtain, according to a query term inputted by a user, promotion information matching the query term. The feature unit 220 is used to obtain a content feature of the promotion information, a content feature of the query term, and a relative feature between the promotion information and the query term based on the promotion information and the query term. The estimation unit 230 is used to obtain an eCTR of the promotion information using an estimation model based on a PS of the promotion information, the content feature of the promotion information, the content feature of the query term, and the relative feature between the promotion information and the query term. The scoring unit 240 is used to obtain an RS of the promotion information based on the eCTR and a bid price of the query term. The determination unit 250 is used to determine a position for presenting the promotion information based on the RS.

It should be noted that the apparatus 200 for processing promotion information provided by this embodiment may be a search engine, and may be located in a local application or in a server on a network side, which is not specifically limited in this embodiment.

It can be understood that the application may be an application program (native app) installed in a terminal, or a web page (web app) of a browser in the terminal, and may exist in any objective form as long as being capable of implementing a search based on a query term to provide promotion information matching the query term. This embodiment does not impose any limitation thereon.

Optionally, in an implementation, the matching unit 210 may use an exact matching method to match exactly a keyword that is selected by a promoter for the promotion information and corresponding to the query term inputted by the user, or the matching unit 210 may use a fuzzy matching method to match approximately a keyword that is selected by the promoter for the promotion information and corresponding to the query term inputted by the user, and further obtains the promotion information bound to the keyword based on the keyword that matches the query term. This embodiment does not impose any limitation on the matching method for the query term.

Specifically, the promoter may select one or more related keywords for promotion information based on the promotion information. For example, if the promotion information is an advertisement of a flower shop, a keyword of “flower” may be selected for the promotion information, or multiple keywords, for example, “flower”, “flower delivery”, and “flower booking” may be selected.

For detailed description of the exact matching method and fuzzy matching method used by the matching unit 210, reference may be made to related content in the existing technologies, which is not redundantly described in detail herein.

It can be understood that the promotion information that the matching unit 210 obtains by performing the corresponding operation may be multiple pieces of promotion information, and any piece of promotion information bound to the keyword that is able to match the query term may be used as an execution result of the operation.

Optionally, in an implementation, the feature unit 220 may obtain the content feature of the promotion information based on the promotion information. Examples include a key term of the title of the promotion information, a high-frequency term in the title of the promotion information, identification information (ID) of the promotion information, a category identifier of the promotion information, and a historical average click through rate of the promotion information.

Optionally, in an implementation, the feature unit 220 may obtain the content feature of the query term based on the query term. Examples include identification information (ID) of the query term, a name in the query term, the query term per se, an adjective in the query term, a model in the query term, and a historical average click through rate of the query term.

Optionally, in an implementation, the feature unit 220 may obtain the relative feature between the promotion information and the query term based on the promotion information and the query term.

Specifically, the relative feature between the promotion information and the query term obtained by the feature unit 220 may include other features, namely, a combined feature of the promotion information and the query term that are apart from a text match feature between the promotion information and the query term and an intention match feature between the promotion information and the query term from among relative features between the promotion information and the query term. An example includes a combined feature of the key term of the title of the promotion information and the query term. Another example may include a combined feature of the ID of the promotion information and the ID of the query term.

Since the text match feature between the query term and the promotion information and the intention match feature between the query term and the promotion information are factors for calculating PS of the promotion information from among the relative features between the promotion information and the query term, the PS of the promotion information may be introduced as a new factor in a calculation of an eCTR in place of the text match feature between the query term and the promotion information and the intention match feature between the query term and the promotion information among the relative features between the promotion information and the query term. Therefore, the text match feature between the query term and the promotion information and the intention match feature between the query term and the promotion information do not need to be involved in the calculation of the eCTR, thus effectively reducing the complexity of eCTR estimation and thereby improving the query efficiency.

Optionally, in an implementation, the estimation unit 230 may obtain the PS of the promotion information corresponding to the promotion information based on the promotion information using a correspondence relationship between pieces of promotion information and respective PSs of the pieces of promotion information, which is obtained in advance.

It can be understood that the promotion information may generally have more than one keyword. Therefore, the promotion information may correspondingly have more than one PSs. Specifically, a determination of which PS is selected by the estimation unit 230 further needs to be performed based on the query term inputted by the user.

For example, the estimation unit 230 may select a PS of the promotion information with respect to a keyword that is most similar to the query term inputted by the user. For a specific matching method, reference may be made to related content of any text matching method in the existing technologies, which is not redundantly described in detail herein.

Specifically, a correspondence relationship between pieces of promotion information and respective PSs of the pieces of promotion information may further be set up. Specifically, a backend operating platform may obtain the text match feature between the promotion information and the keyword and the intention match feature between the promotion information and the keyword based on the promotion information and the keyword of the promotion information. Thereafter, the backend operating platform may obtain a PS of the promotion information using a rule model based on the text match feature between the promotion information and the keyword and the intention match feature between the promotion information and the keyword to set up a correspondence relationship between the promotion information and the PS of the promotion information.

Specifically, the rule model may be obtained by training a Gradient Boosting Decision Tree (GBDT) model using data about user clicking behavior. Features of the rule model may include, but are not limited to, the text match feature between the promotion information and the keyword, and the intention match feature between the promotion information and the keyword.

Specifically, the background operating platform may obtain a text of the keyword according to the keyword, obtain a text of the promotion information according to the promotion information, and thereby obtain the text match feature between the promotion information and the keyword based on the text of the promotion information and the text of the keyword.

For example, the text match feature between the promotion information and the keyword, which is abbreviated as the text match feature hereinafter, may be a matching rate between a term in the keyword and a term in the title of the promotion information. For example, assuming that the keyword is “mp3 player” and the title of the promotion information is “2014 best-selling red mp3”, a term of the keyword that matches with the title is mp3, and a matching rate with respect to a length of the keyword is ½ and a matching rate with respect to a length of the title is ⅕. Generally speaking, the larger the value of the text match feature is, the higher the relevance between the promotion information and the keyword is. In other words, the quality of the promotion information is higher, and the PS of the promotion information is higher.

Specifically, the backend operating platform may obtain an initial intention of the keyword according to the keyword, and obtain an initial intention of the promotion information according to the promotion information, and further obtain the intention match feature between the promotion information and the keyword according to the initial intention of the promotion information and the initial intention of the keyword.

For example, the intention match feature between the promotion information and the keyword, which is abbreviated as the intention match feature hereinafter, may be a parameter indicating whether a key term of the keyword and a key term of the title of the promotion information are the same. For example, the keyword is assumed to be “battery of Nokia phone”, the title of promotion information A is assumed to be “2014 best-selling battery for Nokia phone, the lowest price”, and the title of promotion information B is assumed to be “2014 best-selling Nokia phone, with battery the best performance”. In terms of the text match feature, a matching rate between a term in the keyword and a term in the title of promotion information A and a matching rate between a term in the keyword and a term in the title of promotion information B are both 3/10, that is, respective text match features are the same. However, the key term of the keyword is battery (i.e., the user desires a search result to be battery), the key term of the title of promotion information A is battery (i.e., battery for Nokia phone), and the key term of the title of promotion information B is Nokia phone; the relevance between the keyword and promotion information A is measured to be higher than the relevance between the keyword and promotion information B using the intention match feature, that is, the quality of promotion information A is better than the quality of promotion information B.

The meaning of some keywords covers a wide range, and thus an initial intention of a keyword may not be accurately determined based on the keyword. Optionally, the backend operating platform may obtain a category match feature corresponding to the keyword according to a preset correspondence relationship between keywords and category match features, and thereby obtain an initial intention of the keyword based on the keyword and the category match feature. Specifically, the backend operating platform may obtain the correspondence relationship between the keywords and the category match features based on data associated with user clicking behavior. In this way, the reliability of acquiring the intention match feature between the promotion information and the keyword can be effectively improved, thereby improving the accuracy of the PS calculation.

For example, if no auxiliary information exists, the backend operating platform may hardly obtain a real intention of a user with regard to a keyword of “2014 women”, resulting in a difficulty of the backend operating platform to provide promotion information expected by the user. If data about user clicking behavior in a specified time range, for example, in the last month, shows that 60% of the users click products belonging to a category of female clothes and 40% of the users click products belonging to a category of female shoes after users input the query term “2014 women”, the backend operating platform may predict that the category match feature of the keyword “2014 women” corresponds to female clothes and female shoes based on the data about the user clicking behavior. With this prediction result for the category match feature of “2014 women”, a PS of promotion information is determined as “excellent” when a promoter uses the backend operating platform to push the promotion information belonging to categories of female clothes and female shoes and if “2014 women” is selected as a keyword to which the promotion information is bound.

Therefore, in an implementation, a formula that the backend operating platform uses for calculating a PS of promotion information may be expressed as follows:

PS=f1(fea_{—}tm,fea_{—}im,fea_{—}cm),

where fea_tm may represent the text match feature between the promotion information and the keyword; fea_im may represent the intention match feature between the promotion information and the keyword; fea_cm may represent the category match feature; and the function f1 may represent the rule model obtained by training the GBDT model. For detailed description, reference may be made to related content of the GBDT model training method in the existing technologies, which is not described in detail herein.

Key terms of titles of some promotion information or key terms of some keywords may be identified incorrectly, and in this case, an initial intention of promotion information cannot be accurately determined based on a key term recognized. Optionally, the backend operating platform may use a hidden term intervene feature to revise at least one of an initial intention of the keyword and an initial intention of the promotion information to obtain at least one of a revised intention of the keyword and a revised intention of the promotion information, and further obtain the intention match feature between the promotion information and the keyword based on the initial intention of the promotion information and the revised intention of the keyword, the revised keyword of the promotion information and the revised intention of the keyword, or the revised intention of the promotion information and the initial intention of the keyword. In this way, the reliability of acquiring the intention match feature between the promotion information and the keyword can be effectively improved, thus improving the accuracy of the PS calculation.

For example, the keyword is assumed to be “iPhone” and the title of the promotion information is assumed to be “2014 best-selling iPhone case”. If “iPhone” is recognized as the key term of the title, the backend operating platform will determine the promotion information matches an intention of the keyword. However, content of the promotion information is actually an iPhone case, wherein “case” is a hidden term. In other words, the promotion information does not match the intention of the keyword. In order to avoid the situation described above, the backend operating platform may use a stored hidden term intervene feature. If the title of the promotion information includes “case”, the backend operating platform will revise the key term “iPhone” of the title as “iPhone case” to ensure that the real intention of the promotion information can be recognized correctly and is not misunderstood.

Therefore, in another implementation, a formula that the backend operating platform uses for calculating the PS of the promotion information may be expressed in a form as follows:

PS=f1(fea_{—}tm,fea_{—}im,fea_{—}it),

where fea_tm may represent the text match feature between the promotion information and the keyword; fea_im may represent the intention match feature between the promotion information and the keyword; fea_it may represent the hidden term intervene feature; and the function f1 may represent the rule model obtained by training the GBDT model. For detailed description, reference may be made to related content of the GBDT model training method in the existing technologies, which will not be described in detail herein.

With reference to the content provided by the two implementations described above, in another implementation, a formula that the background operating platform uses for calculating the PS of the promotion information may be expressed in a form as follows:

PS=f1(fea_{—}tm,fea_{—}im,fea_{—}it,fea_{—}cm),

where fea_tm may represent the text match feature between the promotion information and the keyword; fea_im may represent the intention match feature between the promotion information and the keyword; fea_it may represent the hidden term intervene feature; fea_cm may represent the category match feature; and the function f1 may represent the rule model obtained by training the GBDT model. For detailed description, reference may be made to related content of the GBDT model training method in the existing technologies, which will not be described in detail herein.

Specifically, the rule model may be obtained by training a Logistic Regression (LR) model by using data about user clicking behavior. Features of the estimation model may include, but are not limited to, the PS of the promotion information, the content feature of the promotion information, the content feature of the query term, and the relative feature between the promotion information and the query term.

Specifically, a content format of the data about user clicking behavior may be represented in Table 1, which may include, but is not limited to, fields such as a query term (Query), identification information of promotion information (Product_ID), a title of the promotion information (Title), a presentation position of the promotion information (Rank), and whether the promotion information is clicked (Is_Click), etc.

Optionally, before training the model using the data about user clicking behavior, the backend operating platform may further perform preprocessing, such as anti-fraud and anti-crawler data filtering, false exposure data filtering, etc., on the data about user clicking behavior.

For example, according to a length of time during which a user stays on each web page, a determination is made as to whether the promotion information is actually exposed (browsed by the user) to filter out false exposure having a too short stay time, thus effectively improving the quality of data about user clicking behavior obtained after preprocessing.

Specifically, a preprocessing model represented by the following formula may be used to preprocess the data about user clicking behavior:

$$P ( {E}_{i} = 1 \vert {t}_{i} ) = \{ \begin{matrix}1 , {t}_{i} \geq T \\ 0 , {t}_{i} < T\end{matrix} ,$$

wherein t represents a stay time, and T is a threshold obtained based on statistics of a large quantity of data. When t≧T, this indicates that the user has stayed on the page long enough, and really browses the promotion information presented on the page, or otherwise, the promotion information presented on the page is not really exposed. For example, when the user quickly drags a scroll bar of a search result page from the top to the bottom, the promotion information presented in the middle is not browsed by the user, and is not counted as a real exposure. Such data may be excluded when selecting sample data to improve the credibility of the sample data for the estimation model.

Based on the above description, a formula that the estimation unit 230 uses for calculating the eCTR may be expressed in a form as follows:

eCTR=f2(fea_{—}p,fea_{—}q,fea_{—}r,fea_{—}ps),

fea_p may represent the content feature of the promotion information (product); fea_q may represent the content feature of the query term (query); fea_r may represent the relative feature between the promotion information and the query term; fea_ps may represent the PS feature of the promotion information; and the function f2 may represent the estimation model obtained by training the LR model. For detailed description, reference may be made to related content of the LR model training method in the existing technologies, which is not redundantly described in detail herein.

Optionally, in an implementation, the scoring unit 240 may obtain the RS of the promotion information using a formula RS=eCTR*BidPrice and based on the eCTR and the bid price of the query term.

Optionally, in an implementation, the determination unit 250 may determine the position for presenting the promotion information based on an inverted order of respective RSs of each piece of promotion information.

In this embodiment, based on a query term inputted by a user and promotion information matching the query term, the feature unit obtains a content feature of the promotion information, a content feature of the query term, and a relative feature between the promotion information and the query term. Accordingly, the estimation unit obtains an eCTR of the promotion information using an estimation model based on a PS of the promotion information, the content feature of the promotion information, the content feature of the query term, and the relative feature between the promotion information and the query term. As such, the scoring unit obtains an RS of the promotion information based on the eCTR and a bid price of the query term, and thereby the determination unit may determine a position for presenting the promotion information based on the RS. Because the PS that is used for representing the quality of the promotion information is introduced as a new factor into the calculation of the eCTR, the consistency between calculation logics of the PS and the RS is ensured. Thus, the problem of inconsistency between the quality of the promotion information and the presentation position of the promotion information caused by the inconsistency between the calculation logics of the PS and the RS can be avoided, thereby improving the effectiveness of pushing the promotion information.

In addition, by employing the technical solutions provided by the present disclosure, a position of presenting promotion information can be improved by optimizing the quality of the promotion information because the PS representing the quality of the promotion information is introduced as a new factor into a calculation of the eCTR, thus satisfying the revenue demand of a promoter in a better manner.

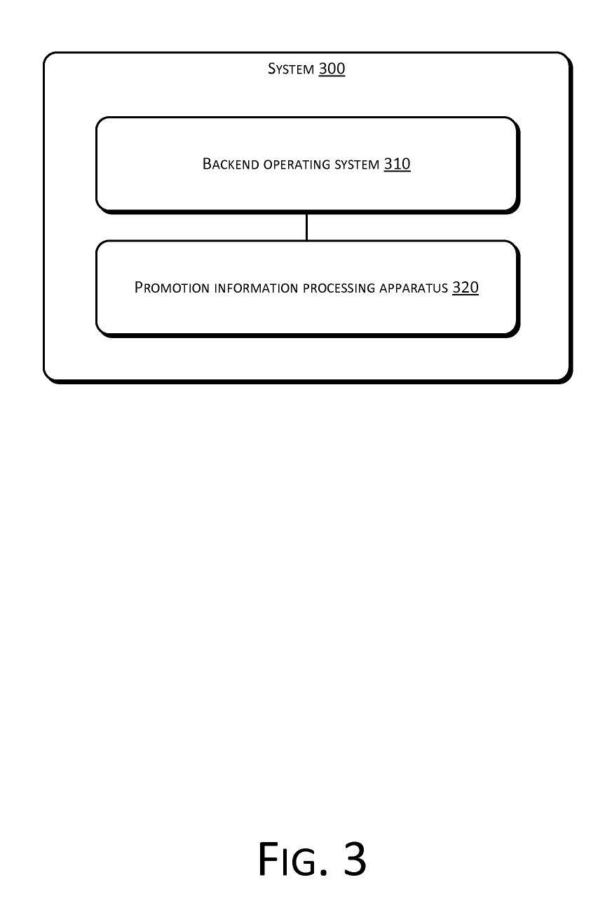

FIG. 3 is a schematic structural diagram of a system 300 of processing promotion information according to another embodiment of the present disclosure. As shown in FIG. 3, the example system 300 of processing promotion information may include a backend operating platform 310 and an apparatus for processing promotion information 320 as provided by the embodiment corresponding to FIG. 2. The backend operating platform 310 is used to obtain a PS of promotion information.

For detailed description of the apparatus for processing promotion information 320, reference may be made to related content in the embodiment corresponding to FIG. 2, which is not redundantly described in detail herein.

Optionally, in an implementation, the backend operating platform 310 may be further used to obtain, based on promotion information and a keyword of the promotion information, a text match feature between the promotion information and the keyword and an intention match feature between the promotion information and the keyword, and obtain the PS of the promotion information using a rule model based on the text match feature between the promotion information and the keyword, and the intention match feature between the promotion information and the keyword.

Optionally, in an implementation, the backend operating platform 310 may be used to obtain an initial intention of the keyword according to the keyword, obtain an initial intention of the promotion information according to the promotion information, and obtain the intention match feature between the promotion information and the keyword based on the initial intention of the promotion information and the initial intention of the keyword.

Optionally, in an implementation, the backend operating platform 310 may be used to obtain a category match feature corresponding to the keyword based on a preset correspondence relationship between keywords and category match features, and obtain the initial intention of the keyword based on the keyword and the category match feature.

Optionally, in an implementation, the backend operating platform 310 may be used to revise at least one of the initial intention of the keyword and the initial intention of the promotion information using a hidden term intervene feature to obtain at least one of a revised intention of the keyword and a revised intention of the promotion information, and obtain the intention match feature between the promotion information and the keyword based on the initial intention of the promotion information and the revised intention of the keyword, the revised keyword of the promotion information and the revised intention of the keyword, or the revised intention of the promotion information and the initial intention of the keyword.

In this embodiment, based on a query term inputted by a user and promotion information that matches the query term, a content feature of the promotion information, a content feature of the query term, and a relative feature between the promotion information and the query term are obtained. Accordingly, an eCTR of the promotion information is obtained using an estimation model based on a PS of the promotion information, the content feature of the promotion information, the content feature of the query term, and the relative feature between the promotion information and the query term. As such, an RS of the promotion information may be obtained based on the eCTR and a bid price of the query term. A presentation position of the promotion information may be determined based on the RS accordingly. Because the PS that is used for representing the quality of the promotion information is introduced as a new factor to the calculation of the eCTR, the consistency between calculation logics of the PS and RS is ensured. Thus, the problem of inconsistency between the quality of the promotion information and the presentation position of the promotion information caused by the inconsistency between the calculation logic of the PS and RS can be avoided, thereby improving the effectiveness of pushing the promotion information.

In addition, by employing the technical solutions provided by the present disclosure, a position of presenting promotion information can be improved by optimizing the quality of the promotion information because the PS representing the quality of the promotion information is introduced as a new factor into a calculation of the eCTR, thus satisfying the revenue demand of a promoter in a better manner.

In addition, by using the technical solutions provided by the present disclosure, since a text match feature between the query term and the promotion information and an intention match feature between the query term and the promotion information are calculation factors of the PS of the promotion information among relative features between the promotion information and the query term, the PS of the promotion information may be introduced as a new calculation factor for the eCTR in place of the text match feature between the query term and the promotion information and the intention match feature between the query term and the promotion information among the relative features between the promotion information and the query term. Therefore, the text match feature between the query term and the promotion information and the intention match feature between the query term and the promotion information do not need to participate in a calculation for the eCTR, thus effectively reducing the complexity of eCTR estimation, and thereby improving the query efficiency.

In addition, by using the technical solutions provided by the present disclosure, a calculation logic of the PS of the promotion information is not changed. Therefore, in a situation where content of the promotion information does not change, the PS of the promotion information only needs to be calculated once before being stored into a database, and does not need to be updated, thus effectively avoiding a waste of computing resources and not affecting computing performance.

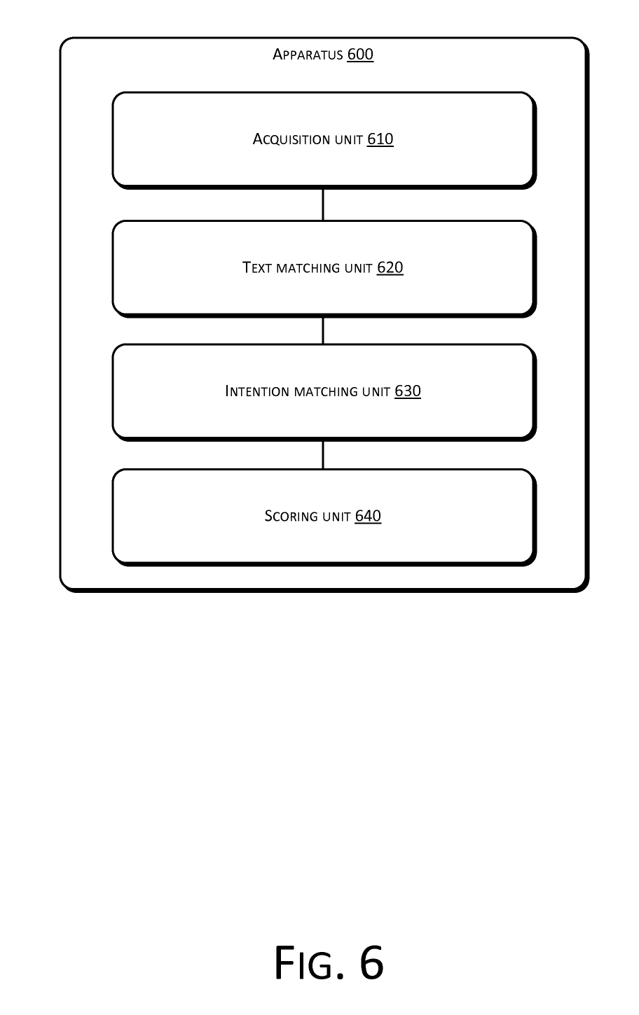

FIG. 6 is a schematic structural diagram of another apparatus 600 for processing promotion information according to another embodiment of the present disclosure. As shown in FIG. 6, the apparatus 600 for processing promotion information provided by this embodiment may include an acquisition unit 610, a text matching unit 620, an intention matching unit 630, and a scoring unit 640. The acquisition unit 610 is used to acquire promotion information to be processed. The text matching unit 620 is used to obtain a text match feature between the promotion information and a keyword based on the promotion information, the keyword of the promotion information and a category match feature. The intention matching unit 630 is used to obtain an intention match feature between the promotion information and the keyword based on the promotion information and the keyword of the promotion information. The scoring unit 640 is used to obtain a PS of the promotion information with respect to the keyword using a rule model based on the text match feature between the promotion information and the keyword, and the intention match feature between the promotion information and the keyword.

It should be noted that the apparatus 600 for processing promotion information provided by this embodiment may be located in a backend operating platform on a network side, on which this embodiment does not impose any limitation.

Specifically, the rule model may be obtained by training a Gradient Boosting Decision Tree (GBDT) model using data about user clicking behavior. Features of the rule model may include, but are not limited to, the text match feature between the promotion information and the keyword, and the intention match feature between the promotion information and the keyword, etc.

Optionally, in an implementation, the text matching unit 620 may obtain a text of the keyword according to the keyword, obtain a text of the promotion information according to the promotion information, and further obtain the text match feature between the promotion information and the keyword based on the text of the promotion information and the text of the keyword.

For example, the text match feature between the promotion information and the keyword, which is abbreviated as the text match feature hereinafter, may be a matching rate between a term in the keyword and a term in the title of the promotion information. For example, if the keyword is “mp3 player” and the title of the promotion information is “2014 best-selling red mp3”, a matching word between the keyword and the title is mp3, a matching rate with respect to a length of the keyword is ½, and a matching rate with respect to a length of the title is ⅕. Generally speaking, a larger value of the text match feature indicates a higher relevance between the promotion information and the keyword, i.e., a higher quality of the promotion information. Thus, the PS of the promotion information is higher.

Optionally, in an implementation, the intention matching unit 630 may be used to obtain an initial intention of the keyword according to the keyword, obtain an initial intention of the promotion information according to the promotion information, and further obtain the intention match feature between the promotion information and the keyword based on the initial intention of the promotion information and the initial intention of the keyword.

For example, the intention match feature between the promotion information and the keyword, which is abbreviated as the intention match feature hereinafter, may be a parameter indicating whether a key term of the keyword and a key term of the title of the promotion information are the same. For example, the keyword is assumed to “battery of Nokia phone”, the title of promotion information A is assumed to “2014 best-selling battery for Nokia phone, the lowest price”, and the title of promotion information B is assumed to “2014 best-selling Nokia phone, with battery the best performance”. In terms of the text match feature, a matching rate between a term in the keyword and a term in the title of promotion information A and a matching rate between a term in the keyword and a term in the title of promotion information B are both 3/10, that is, respective text match features are the same. However, a key term of the keyword is battery (the user desire a search result as battery), a key term of the title of promotion information A is battery (battery for Nokia phone), and a key term of the title of promotion information B is Nokia phone. Using the intention match feature, the relevance between the keyword and promotion information A is measured to be higher than the relevance between the keyword and promotion information B, that is, the quality of promotion information A is better than the quality of promotion information B.

The meaning of some keywords covers a wide range, and thus an initial intention of the keyword may not be accurately determined based on the keyword. Specifically, the intention matching unit 630 may obtain a category match feature corresponding to the keyword according to a preset correspondence relationship between keywords and category match features, and thereby obtain an initial intention of the keyword based on the keyword and the category match feature. Specifically, the processing apparatus may obtain a correspondence relationship between keywords and category match features based on data associated with user clicking activities. In this way, the reliability of acquiring the intention match feature between the promotion information and the keyword can be effectively improved, thereby improving the accuracy of the PS calculation.

For example, if no auxiliary information exists, the intention matching unit 630 may hardly obtain a real intention of a user with regard to a keyword of “2014 women”, resulting in a difficulty of the processing apparatus to provide promotion information expected by the user. If data about user clicking behavior in a specified time range, for example, in the last month, shows that 60% of the users click products belonging to a category of female clothes and 40% of the users click products belonging to a category of female shoes after users input the query term “2014 women”, the intention matching unit 630 may predict that the category match feature of the keyword “2014 women” corresponds to female clothes and female shoes based on the data about the user clicking behavior. With this prediction result for the category match feature of “2014 women”, a PS of promotion information is determined as “excellent” when a promoter uses the processing apparatus to push the promotion information belonging to categories of female clothes and female shoes and if “2014 women” is selected as a keyword to which the promotion information is bound.

Therefore, in an implementation, a formula that the scoring unit 640 uses for calculating the PS of the promotion information may be expressed in a form as follows:

PS=f1(fea_{—}tm,fea_{—}im,fea_{—}cm),

where fea_tm may represent the text match feature between the promotion information and the keyword; fea_im may represent the intention match feature between the promotion information and the keyword; fea_cm may represent the category match feature; and the function f1 may represent the rule model obtained by training the GBDT model. For detailed description, reference may be made to related content of the GBDT model training method in the existing technologies, which is not redundantly described in detail herein.

In this embodiment, the intention matching unit obtains a category match feature corresponding to the keyword according to a preset correspondence relationship between keywords and category match features, and further obtains an initial intention of the keyword based on the keyword and the category match feature, so that the reliability of acquiring the intention match feature between the promotion information and the keyword can be effectively improved, thereby improving the accuracy of the PS calculation.

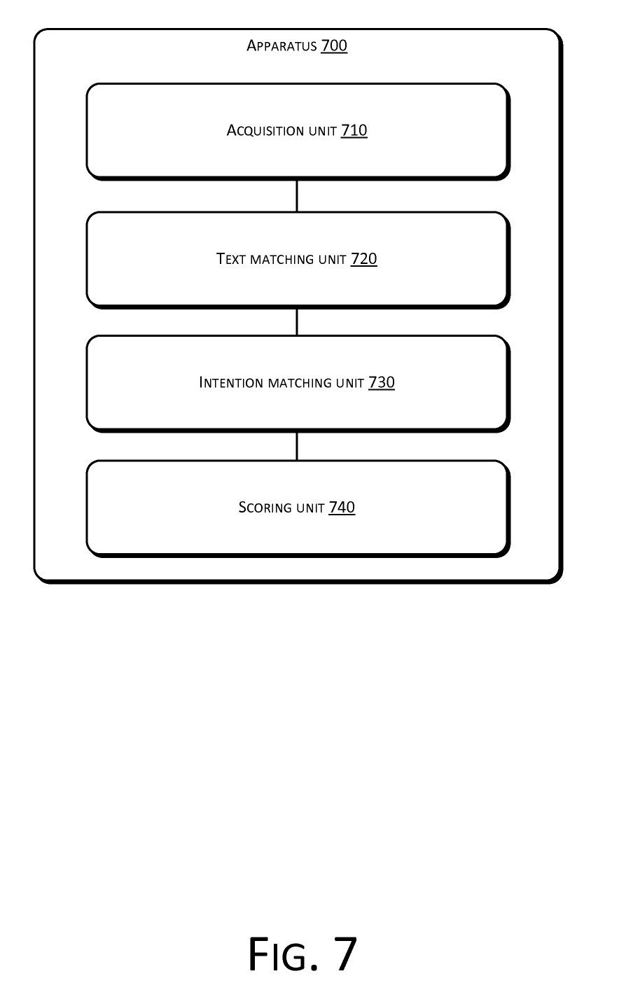

FIG. 7 is a schematic structural diagram of another apparatus 700 for processing promotion information according to another embodiment of the present disclosure. As shown in FIG. 7, the apparatus 700 for processing promotion information provided by this embodiment may include an acquisition unit 710, a text matching unit 720, an intention matching unit 730, and a scoring unit 740. The acquisition unit 710 is used to acquire promotion information to be processed. The text matching unit 720 is used to obtain, based on the promotion information and a keyword of the promotion information, a text match feature between the promotion information and the keyword. The intention matching unit 730 is used to obtain an intention match feature between the promotion information and the keyword based on the promotion information, the keyword of the promotion information and a hidden term intervene feature. The scoring unit 740 is used to obtain a PS of the promotion information with respect to the keyword using a rule model based on the text match feature between the promotion information and the keyword, and the intention match feature between the promotion information and the keyword.

It should be noted that the apparatus 700 for processing promotion information provided by this embodiment may be located in a backend operating platform on a network side, which this embodiment does not impose any limitation thereon.

Specifically, the rule model may be obtained by training a Gradient Boosting Decision Tree (GBDT) model using data associated with user clicking activities. Features of the rule model may include, but are not limited to, the text match feature between the promotion information and the keyword, and the intention match feature between the promotion information and the keyword, etc.

Optionally, in an implementation, the text matching unit 720 may be used to obtain a text of the keyword according to the keyword, obtain a text of the promotion information according to the promotion information, and further obtain the text match feature between the promotion information and the keyword based on the text of the promotion information and the text of the keyword.

For example, the text match feature between the promotion information and the keyword, which is abbreviated as the text match feature hereinafter, may be a matching rate between a term in the keyword and a term in the title of the promotion information. For example, if the keyword is “mp3 player” and the title of the promotion information is “2014 best-selling red mp3”, a matching word between the keyword and the title is mp3, a matching rate with respect to a length of the keyword is ½, and a matching rate with respect to a length of the title is ⅕. Generally speaking, a larger value of the text match feature indicates a higher relevance between the promotion information and the keyword, i.e., a higher quality of the promotion information. Thus, the PS of the promotion information is higher.

Optionally, in an implementation, the intention matching unit 730 may be used to obtain an initial intention of the keyword according to the keyword, obtain an initial intention of the promotion information according to the promotion information, and thereby obtain the intention match feature between the promotion information and the keyword based on the initial intention of the promotion information and the initial intention of the keyword.

For example, the intention match feature between the promotion information and the keyword, which is abbreviated as the intention match feature hereinafter, may be a parameter indicating whether a key term of the keyword and a key term of the title of the promotion information are the same. For example, the keyword is assumed to “battery of Nokia phone”, the title of promotion information A is assumed to “2014 best-selling battery for Nokia phone, the lowest price”, and the title of promotion information B is assumed to “2014 best-selling Nokia phone, with battery the best performance”. In terms of the text match feature, a matching rate between a term in the keyword and a term in the title of promotion information A and a matching rate between a term in the keyword and a term in the title of promotion information B are both 3/10, that is, respective text match features are the same. However, a key term of the keyword is battery (the user desire a search result as battery), a key term of the title of promotion information A is battery (battery for Nokia phone), and a key term of the title of promotion information B is Nokia phone. Using the intention match feature, the relevance between the keyword and promotion information A is measured to be higher than the relevance between the keyword and promotion information B, that is, the quality of promotion information A is better than the quality of promotion information B.

Key terms of titles of some promotion information or key terms of some keywords may be identified incorrectly, and in this case, an initial intention of promotion information cannot be accurately determined based on a key term recognized. Specifically, the intention matching unit 730 may use a hidden term intervene feature to revise at least one of an initial intention of the keyword and an initial intention of the promotion information to obtain at least one of a revised intention of the keyword and a revised intention of the promotion information, and further obtain the intention match feature between the promotion information and the keyword based on the initial intention of the promotion information and the revised intention of the keyword, the revised keyword of the promotion information and the revised intention of the keyword, or the revised intention of the promotion information and the initial intention of the keyword. In this way, the reliability of acquiring the intention match feature between the promotion information and the keyword can be effectively improved, thus improving the accuracy of the PS calculation.

For example, the keyword is assumed to be “iPhone” and the title of the promotion information is assumed to be “2014 best-selling iPhone case”. If “iPhone” is recognized as the key term of the title, the backend operating platform will determine the promotion information matches an intention of the keyword. However, content of the promotion information is actually an iPhone case, wherein “case” is a hidden term. In other words, the promotion information does not match the intention of the keyword. In order to avoid the situation described above, the intention matching unit 730 may use a stored hidden term intervene feature. If the title of the promotion information includes “case”, the backend operating platform will revise the key term “iPhone” of the title as “iPhone case” to ensure that the real intention of the promotion information can be recognized correctly and is not misunderstood.

Therefore, in another implementation, a formula that the scoring unit 740 uses for calculating the PS of the promotion information may be expressed in a form as follows:

PS=f1(fea_{—}tm,fea_{—}im,fea_{—}it),

where fea_tm may represent the text match feature between the promotion information and the keyword; fea_im may represent the intention match feature between the promotion information and the keyword; fea_it may represent the hidden term intervene feature; and the function f1 may represent the rule model obtained by training the GBDT model. For detailed description, reference may be made to related content of the GBDT model training method in the existing technologies, which is not redundantly described in detail herein.

In this embodiment, the intention matching unit revises at least one of an initial intention of a keyword and an initial intention of promotion information is revised using a hidden term intervene feature to obtain at least one of a revised intention of the keyword and a revised intention of the promotion information. As such, an intention match feature between the promotion information and the keyword is obtained based on the initial intention of the promotion information of the revised intention of the keyword, the revised intention of the promotion information and the revised intention of the keyword, or the revised intention of the promotion information and the initial intention of the keyword. Therefore, the reliability of acquiring the intention match feature between the promotion information and the keyword can be effectively improved, thereby improving the accuracy of the PS calculation.

One of ordinary skill in the art can clearly understand that, in order to make the description convenient and simple, specific working processes of the system, apparatus, and units described above may be referenced to corresponding processes in the foregoing method embodiments, and details thereof are not redundantly described herein.

In the embodiments provided in the present disclosure, it should be understood that the disclosed systems, apparatuses and methods may be implemented in other manners. For example, the described apparatus embodiment is merely schematic. For instance, the division of units is merely a division based on logical functions, and other manners of division may be possible in a real implementation. For example, a plurality of units or components may be combined or integrated into another system. Alternatively, some features may be ignored or not performed. In addition, the mutual couplings, direct couplings or communication connections as displayed or discussed may be implemented through some interfaces. The indirect couplings or communication connections between apparatuses or units may be in electrical, mechanical or other forms.

The units described as separate parts may or may not be physically separate. The components displayed as units may or may not be physical units, i.e., may be located at a single location, or distributed over a plurality of network units. Some or all of the units may be selected according to an actual need to implement the objectives of the solutions of the embodiments.

In addition, the functional units in the embodiments of the present disclosure may be integrated into a single processing unit. Alternatively, each of the units may exists as physically independent. Alternatively, or two or more units may be integrated into a single unit. The integrated unit described above may be implemented in a hardware form, or in a form of hardware plus a software functional unit.

The integrated unit implemented in the form of a software functional unit may be stored in a computer-readable storage medium. The software functional unit is stored in a storage medium, and includes multiple instructions to cause a computing device (which may be a personal computer, a server, a network device, or the like) or a processor to perform some acts of the method described in the embodiments of the present disclosure. The foregoing storage medium includes a medium that is capable of storing program codes, such as a USB flash disk, a removable hard disk, a Read-Only Memory (ROM), a Random Access Memory (RAM), a magnetic disk, an optical disc, etc.

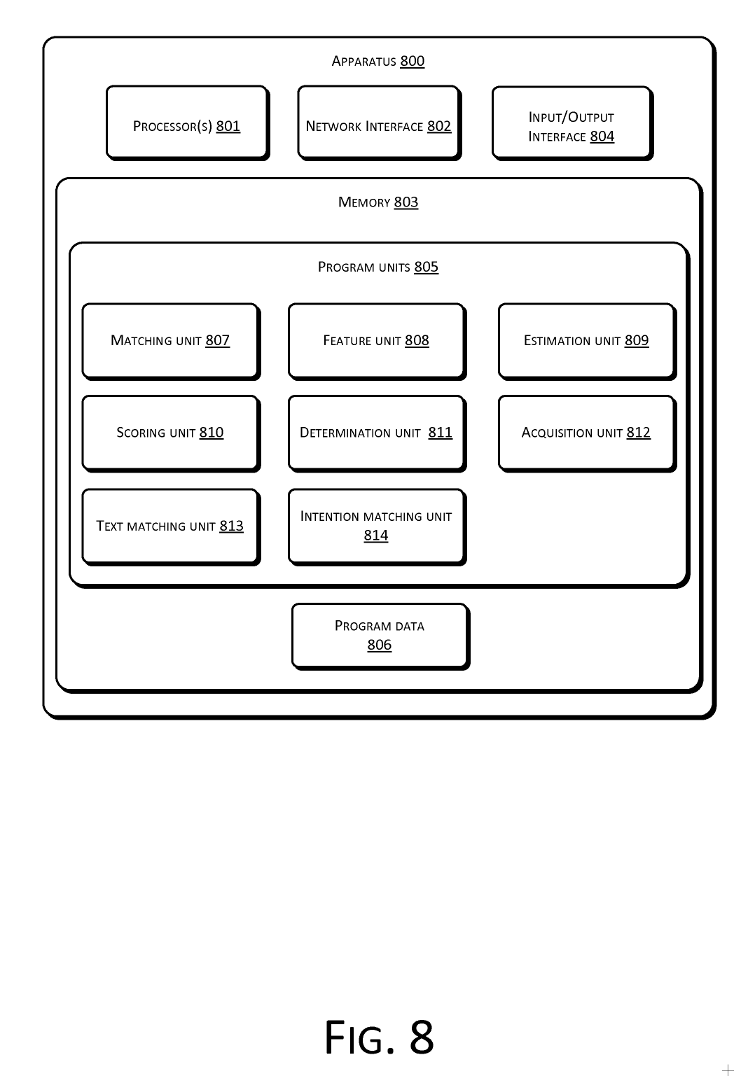

For example, FIG. 8 shows an example apparatus 800, such the apparatuses and systems as described above, in more detail. In an embodiment, the apparatus 800 may include, but is not limited to, one or more processors 801, a network interface 802, memory 803 and an input/output interface 804.

The memory 803 may include a form of computer readable media such as a volatile memory, a random access memory (RAM) and/or a non-volatile memory, for example, a read-only memory (ROM) or a flash RAM. The memory 803 is an example of a computer readable media.

The computer readable media may include a permanent or non-permanent type, a removable or non-removable media, which may achieve storage of information using any method or technology. The information may include a computer-readable command, a data structure, a program module or other data. Examples of computer storage media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer readable media does not include transitory media, such as modulated data signals and carrier waves.

The memory 803 may include program units 805 and program data 806. Depending on which apparatus (such as the apparatus 20, 60 or 70, etc.) or system (e.g., the system 30, etc.) that the apparatus 800 corresponds to, the program units 805 may include one or more units as described in the foregoing embodiments. By way of examples, the program units 805 may include a matching unit 807, a feature unit 808, an estimation unit 809, a scoring unit 810, a determination unit 811, an acquisition unit 812, a text matching unit 813 and/or an intention matching unit 814. Details of these units may be found in the foregoing description and are therefore not redundantly described herein.

Finally, it should be noted that the foregoing embodiments are merely used to describe rather than limit the technical solutions of the present disclosure. Although the present disclosure is described in detail with reference to the foregoing embodiments, one of ordinary skill in the art should understand that the technical solutions described in the foregoing embodiments may be modified or some technical features therein may be replaced with equivalent features. These modifications or replacements do not cause the essence of the corresponding technical solutions to depart from the spirit and scope of the technical solutions of the embodiments of the present disclosure.

1. A method implemented by one or more computing devices, the method comprising:
obtaining promotion information matching a query term;
obtaining a content feature of the promotion information, a content feature of the query term, and a relative feature between the promotion information and the query term based at least in part on the promotion information and the query term;
obtaining an estimated Click Through Rate (eCTR) of the promotion information using an estimation model based at least in part on a Promotion Score (PS) of the promotion information, the content feature of the promotion information, the content feature of the query term, and the relative feature between the promotion information and the query term;
obtaining a Rank Score (RS) of the promotion information based at least in part on the eCTR and a bid price of the query term; and
determining a position for presenting the promotion information based at least in part on the RS.

2. The method of claim 1, further comprising:
obtaining, based at least in part on the promotion information and a keyword of the promotion information, a text match feature between the promotion information and the keyword, and an intention match feature between the promotion information and the keyword; and
obtaining the PS of the promotion information using a rule model based at least in part on the text match feature and the intention match feature.

3. The method of claim 2, wherein obtaining the intention match feature comprises:
obtaining a keyword initial intention of the keyword according to the keyword;
obtaining a promotion initial intention of the promotion information according to the promotion information; and
obtaining the intention match feature between the promotion information and the keyword based at least in part on the keyword initial intention and the promotion initial intention.

4. The method of claim 3, wherein obtaining the initial intention of the keyword comprises:
obtaining a category match feature corresponding to the keyword based at least in part on a preset correspondence relationship between keywords and category match features; and
obtaining the keyword initial intention based at least in part on the keyword and the category match feature.

5. The method of claim 3, wherein obtaining the intention match feature comprises:
revising at least one of the keyword initial intention and the promotion initial intention using a hidden term intervene feature to obtain at least one of a revised intention of the keyword and a revised intention of the promotion information; and
obtaining the intention match feature between the promotion information and the keyword based on the promotion initial intention and the revised intention of the keyword, the revised intention of the promotion information and the revised intention of the keyword, or the revised intention of the promotion information and the keyword initial intention.

6. The method of claim 1, further comprising obtaining the rule model by training a Gradient Boosting Decision Tree (GBDT) model or a Logistic Regression (LR) model using data associated with user clicking activities.

7. The method of claim 1, wherein the relative feature between the promotion information and the query term comprises a combined feature of the promotion information and the query term.

8. The method of claim 1, wherein the content feature of the promotion information comprises one or more of: a key term of a title of the promotion information, a high-frequency term in the title of the promotion information, identification information (ID) of the promotion information, a category identifier of the promotion information, and a historical average click through rate of the promotion information.

9. The method of claim 1, wherein the content feature of the query term comprises identification information (ID) of the query term, a name in the query term, the query term per se, an adjective in the query term, a model in the query term, and a historical average click through rate of the query term.

10. The method of claim 1, wherein the relative feature between the promotion information and the query term comprises one or more of: a combined feature of a key term of a title of the promotion information and the query term, and a combined feature of identification information (ID) of the promotion information and ID of the query term.

11. One or more computer-readable media storing executable instructions that, when executed by one or more processors, cause the one or more processors to perform acts comprising:
obtaining promotion information matching a query term;
obtaining a content feature of the promotion information, a content feature of the query term, and a relative feature between the promotion information and the query term based at least in part on the promotion information and the query term;
obtaining an estimated Click Through Rate (eCTR) of the promotion information using an estimation model based at least in part on a Promotion Score (PS) of the promotion information, the content feature of the promotion information, the content feature of the query term, and the relative feature between the promotion information and the query term;
obtaining a Rank Score (RS) of the promotion information based at least in part on the eCTR and a bid price of the query term; and
determining a position for presenting the promotion information based at least in part on the RS.

12. The one or more computer-readable media of claim 11, the acts further comprising:
obtaining, based at least in part on the promotion information and a keyword of the promotion information, a text match feature between the promotion information and the keyword, and an intention match feature between the promotion information and the keyword; and
obtaining the PS of the promotion information using a rule model based at least in part on the text match feature between the promotion information and the keyword, and the intention match feature between the promotion information and the keyword.

13. The one or more computer-readable media of claim 12, wherein obtaining the intention match feature comprises:
obtaining an initial intention of the keyword according to the keyword;
obtaining an initial intention of the promotion information according to the promotion information; and
obtaining the intention match feature between the promotion information and the keyword based at least in part on the initial intention of the promotion information and the initial intention of the keyword.

14. The one or more computer-readable media of claim 13, wherein obtaining the initial intention of the keyword comprises:
obtaining a category match feature corresponding to the keyword based at least in part on a preset correspondence relationship between keywords and category match features; and
obtaining the initial intention of the keyword based at least in part on the keyword and the category match feature.

15. The one or more computer-readable media of claim 13, wherein obtaining the intention match feature comprises:
revising at least one of the initial intention of the keyword and the initial intention of the promotion information using a hidden term intervene feature to obtain at least one of a revised intention of the keyword and a revised intention of the promotion information; and
obtaining the intention match feature between the promotion information and the keyword based on the initial intention of the promotion information and the revised intention of the keyword, the revised intention of the promotion information and the revised intention of the keyword, or the revised intention of the promotion information and the initial intention of the keyword.

16. An apparatus comprising:
one or more processors;
memory;
an acquisition unit stored in the memory and executable by the one or more processors to obtain promotion information to be processed;
a text matching unit stored in the memory and executable by the one or more processors to obtain, based on the promotion information and a keyword of the promotion information, a text match feature between the promotion information and the keyword;
an intention matching unit stored in the memory and executable by the one or more processors to obtain an intention match feature between the promotion information and the keyword based on the promotion information, the keyword of the promotion information, and a hidden term intervene feature; and
a scoring unit stored in the memory and executable by the one or more processors to obtain a Promotion Score (PS) of the promotion information with respect to the keyword using a rule model based on the text match feature and the intention match feature.

17. The apparatus of claim 16, wherein the intention matching unit further obtains an initial intention of the keyword according to the keyword, obtains an initial intention of the promotion information according to the promotion information, and revises at least one of the initial intention of the keyword and the initial intention of the promotion information using the hidden term intervene feature to obtain at least one of a revised intention of the keyword and a revised intention of the promotion information.

18. The apparatus of claim 17, wherein the intention matching unit further obtains the intention match feature between the promotion information and the keyword based further on the initial intention of the promotion information and the revised intention of the keyword, the revised intention of the promotion information and the revised intention of the keyword, or the revised intention of the promotion information and the initial intention of the keyword.

19. The apparatus of claim 16, wherein the text matching unit further obtains an initial intention of the keyword according to the keyword, obtains an initial intention of the promotion information according to the promotion information, and obtains the intention match feature between the promotion information and the keyword based at least in part on the initial intention of the promotion information and the initial intention of the keyword.

20. The apparatus of claim 16, wherein the rule model is obtained by training a Gradient Boosting Decision Tree (GBDT) model or a Logistic Regression (LR) model using data associated with user clicking activities.
